(19) United States
(12) Patent Application Publication
(10) Pub. No.: US 2025/0350183 A1
(43) Pub. Date: Nov. 13, 2025

(54) SYSTEMS AND METHODS FOR MINIMIZING VOLTAGE UNDERSHOOT DURING TRANSITION BETWEEN POWER MODES IN A POWER CONVERTER

(71) Applicant: Cirrus Logic International Semiconductor Ltd., Edinburgh (GB)

(72) Inventors: Siddharth MARU, Austin, TX (US); Kaan TOSUN, Austin, TX (US); Rosario PAGANO, Mesa, AZ (US)

(73) Assignee: Cirrus Logic International Semiconductor Ltd., Edinburgh (GB)

(21) Appl. No.: 19/176,284

(22) Filed: Apr. 11, 2025

Related U.S. Application Data
(60) Provisional application No. 63/644,680, filed on May 9, 2024.
(60) Provisional application No. 63/757,937, filed on Feb. 13, 2025.

(30) Foreign Application Priority Data
Feb. 24, 2025 (GB) 2502637.8

(51) Int. Cl. H02M 1/00; H02M 3/157; H02M 3/158

(52) U.S. Cl. CPC H02M 1/0019; H02M 1/0032; H02M 3/157; H02M 3/158

(57) ABSTRACT

A system may include a power converter configured to operate in a plurality of modes including a low-power mode, a transitional mode, and a high-power mode, and further configured to generate a load current to a load coupled to the output of the power converter and a controller configured to during operation in the low-power mode, infer an increase in the load current; in response to inferring the increase in the load current, enter the transitional mode to enable circuitry associated with the high-power mode; and transition from the transitional mode to operation in the high-power mode once the circuitry associated with the high-power mode is fully enabled.

### RELATED APPLICATION

The present disclosure claims priority to United Kingdom Patent Application No. 2502637.8, filed Feb. 24, 2025, U.S. Provisional Patent Application Ser. No. 63/757,937 filed Feb. 13, 2025, and U.S. Provisional Patent Application Ser. No. 63/644,680 filed May 9, 2024, each of which is incorporated by reference herein in its entirety.

### FIELD OF DISCLOSURE

The present disclosure relates in general to circuits for electronic devices, including without limitation personal audio devices such as wireless telephones and media players, camera and image sensors, visual displays, and wireless communications devices, and more specifically, systems and methods for minimizing voltage undershoot during a transition between a low-power mode and a high power mode in a power converter.

### BACKGROUND

Electronic devices, including wireless telephones, such as mobile/cellular telephones, cordless telephones, mp3 players, cameras, and other electronic devices, are in widespread use. Such electronic devices may include circuitry for driving any suitable collection of electrical or electronic components, including without limitation speakers, headphones, motors, haptic actuators, image sensors, cameras, displays, wireless communications circuitry, etc. Oftentimes, a power converter may be used to provide a regulated supply voltage to a power amplifier in order to amplify a signal driven to speakers, headphones, motors, haptic actuators, or other components. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier or a sensor. In addition to a power amplifier or sensor, one or more other critical components of an electronic device may be powered from a stable power rail with a DC voltage regulated by a power converter.

A predominant portion of a DC-DC converter circuit may be implemented within a single power management integrated circuit (PMIC) that provides a regulated supply voltage for a plurality of components, which themselves may be implemented as one or more other integrated circuits. Many portable electronic devices may require a large number of converter circuits in order to generate multiple rail voltages. Portable electronic devices are usually battery operated and may need to be judicious in their use of power in order to ensure a battery maintains charge for as long as possible. Consequently, many of these PMICs and their converter circuits may need only be powered on in accordance with need. Thus, power converters may be off or in a lower power mode for a large portion of time, and turned on or activated only a short time prior to or exactly at the time the component needing the associated voltage supply rail is enabled.

For example, when a load of a DC-DC converter is off, the DC-DC converter may be operated in a lower power mode wherein the DC-DC converter only switches/operates as necessary to replenish charge on an output capacitor that establishes the supply rail. However, the load may become active at any time, generating a sudden current demand, also known as a load transient, from the DC-DC converter. In many instances, the DC-DC converter and its PMIC may have no prior indication of an impending activation of a load, and hence the DC-DC converter may need to respond quickly to any instantaneous reduction of the voltage on the output capacitor due to the applied load and transition to a higher power mode.

An example of a low-power mode may be a discontinuous conduction mode (DCM) or pulse-frequency modulation (PFM) mode of operation. In such a mode, a DC-DC converter may switch infrequently or on an as-needed basis to transfer charge to the converter's output capacitor. When operating in such a low-power mode, a significant portion of the digital and analog circuits supporting the DC-DC converter may be turned off to conserve power. When a sudden load is applied, the DC-DC converter may need to power on all supporting blocks and transition to a high-power mode to support the increased load demand. An example of a high-power mode may comprise a continuous conduction mode (CCM) or pulse-width modulation (PWM) mode of operation.

The finite time taken (e.g., due to the finite time needed to power on supporting blocks of the DC-DC power converter) to transition from a low-power state to a high-power state may cause a perturbation (e.g., voltage undershoot or voltage overshoot) on the supply rail at the output of the DC-DC power-converter. In many cases, it may be critical to limit these perturbations, as voltage undershoots and overshoots may negatively affect operation. Thus, transitions from low-to high-power states and vice versa may need to occur quickly. However, if transitions occur quickly but not smoothly, additional perturbation on the supply rail may occur. Accordingly, systems and methods for providing for smooth transitions between power modes may be desired.

### SUMMARY

In accordance with the teachings of the present disclosure, one or more disadvantages and problems associated with existing approaches to regulating an output voltage of a power converter during transitions between power modes may be reduced or eliminated.

In accordance with embodiments of the present disclosure, a system may include a power converter configured to operate in a plurality of modes including a low-power mode, a transitional mode, and a high-power mode, and further configured to generate a load current to a load coupled to the output of the power converter and a controller configured to during operation in the low-power mode, infer an increase in the load current; in response to inferring the increase in the load current, enter the transitional mode to enable circuitry associated with the high-power mode; and transition from the transitional mode to operation in the high-power mode once the circuitry associated with the high-power mode is fully enabled.

In accordance with these and other embodiments of the present disclosure, a method may include, in a system having a power converter configured to operate in a plurality of modes including a low-power mode, a transitional mode, and a high-power mode, and further configured to generate a load current to a load coupled to the output of the power converter: during operation in the low-power mode, inferring an increase in the load current; in response to inferring the increase in the load current, entering the transitional mode to enable circuitry associated with the high-power mode; and transitioning from the transitional mode to operation in the high-power mode once the circuitry associated with the high-power mode is fully enabled.

Technical advantages of the present disclosure may be readily apparent to one skilled in the art from the figures, description, and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example system for driving a load using a power converter, in accordance with embodiments of the present disclosure;

FIG. 2 illustrates a flow chart of an example method for minimizing undershoot during a transition from a low-power mode to a high-power mode of a power converter, in accordance with embodiments of the present disclosure;

FIG. 3 illustrates an example timing diagram of selected signals and states within the system depicted in FIG. 1 during performance of the method depicted in FIG. 2, in accordance with embodiments of the present disclosure; and

FIG. 4 illustrates an example of a transition from a two-phase pulse-frequency mode to a three-phase pulse frequency mode, in accordance with embodiments of the present disclosure.

### DETAILED DESCRIPTION

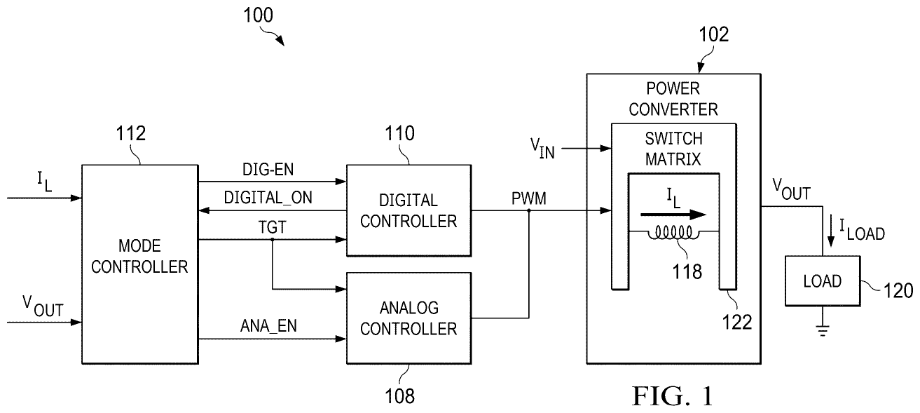

FIG. 1 illustrates a block diagram of selected components of an example system 100 for driving a load 120 using a power converter 102, in accordance with embodiments of the present disclosure. As shown in FIG. 1, system 100 may include power converter 102, an analog controller 108, a digital controller 110, a mode controller 112, and load 120.

Power converter 102 may comprise any suitable system, device, or apparatus configured to drive a power inductor current I_{L} through a power inductor 118 and a load current I_{LOAD} to generate a voltage V_{OUT} from a supply voltage V_{IN} based on one or more switch control signals PWM for controlling switches of a switch matrix 122, wherein such switch control signals are provided from analog controller 108 or digital controller 110. Power converter 102 may comprise any suitable power converter, including a buck converter, buck-boost converter, boost converter, two-level power converter, or multi-level power converter.

Analog controller 108 may comprise any system, device, or apparatus configured to implement a control loop to generate switch control signal(s) based on target signal TGT in order to regulate voltage V_{OUT} (or another physical quantity of system 100) to track target signal TGT during a low-power mode of operation of power converter 102. As its name implies, analog controller 108 may comprise predominantly analog electrical/electronic components. In the low-power mode, analog controller 108 may control power converter 102 to operate in discontinuous conduction mode (DCM) or pulse-frequency modulation (PFM) mode.

Digital controller 110 may comprise any system, device, or apparatus configured to implement a control loop to generate switch control signal(s) based on target signal TGT in order to regulate voltage V_{OUT} (or another physical quantity of system 100) to track target signal TGT during a high-power mode of operation of power converter 102. As its name implies, digital controller 110 may comprise predominantly digital electrical/electronic components. In the high-power mode, digital controller 110 may control power converter 102 to operate in continuous conduction mode (CCM) or pulse-width modulation (PWM) mode. When enabled, digital controller 110 may consume more power than analog controller 108 when enabled.

Mode controller 112 may comprise any system, device, or apparatus configured to, based on power inductor current IL, output voltage V_{OUT}, target signal TGT, and/or other parameters/conditions associated with system 100, determine whether to operate in the low-power mode or the high-power mode, and control operations of analog modulator 108 and digital modulator 110 for the selected mode. For example, in the low-power mode, mode controller 112 may assert an enable signal ANA_EN to activate components of analog controller 108 and deassert an enable signal DIG_EN to disable all or a portion of the components of digital modulator 110. For example, in the high-power mode, mode controller 112 may assert enable signal DIG_EN to activate components of digital controller 110 and deassert enable signal ANA_EN to disable all or a portion of the components of analog modulator 108.

Further, mode controller 112 may be configured to minimize or eliminate voltage undershoot when transitioning from the low-power mode to the high-power mode by executing a low-power exit scheme, as described in greater detail below.

Load 120 may include any appropriate electrical or electronic load that may be powered from power converter 102, including without limitation a rechargeable battery.

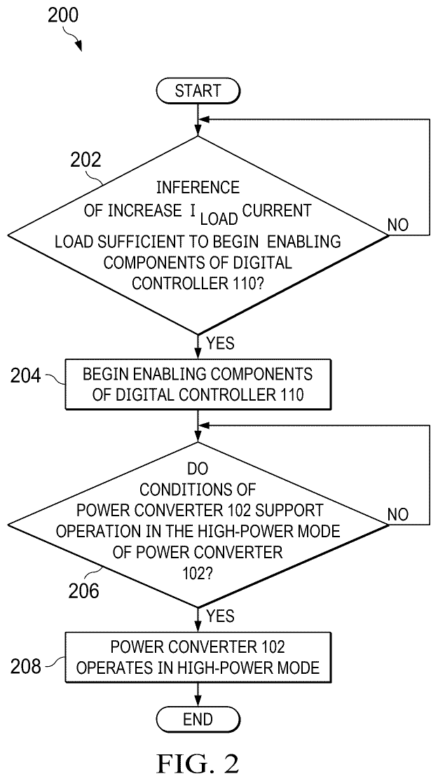

FIG. 2 illustrates a flow chart of an example method 200 for minimizing undershoot during a transition from the low-power mode to the high-power mode of power converter 102, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

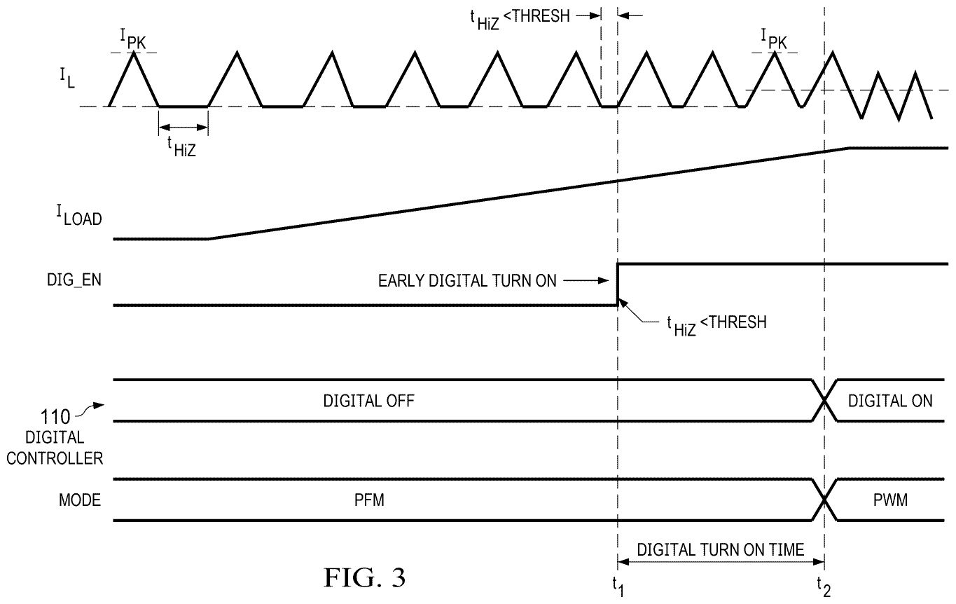

Performance of method 200 may further be understood with reference to FIG. 3. FIG. 3 illustrates an example timing diagram of selected signals and states within system 100 during performance of method 200, in accordance with embodiments of the present disclosure.

At step 202, with power converter 102 already operating in the low-power mode (e.g., DCM/PFM operation), mode controller 112 may infer whether an increase in load current I_{LOAD} is sufficient to begin enabling components of digital controller 110. Mode controller 112 may infer such an increase in load current I_{LOAD} in any suitable manner. For example, in some embodiments, mode controller 112 may determine a duration of time _{HiZ} within a PFM switching cycle that switches of switch matrix 122 are in a high-impedance mode (e.g., such switches are disabled, turned off, or deactivated). Such duration of time t_{HIZ} may be determined by analyzing power inductor current I_{L} to determine the duration of time within each PFM switching cycle that power inductor current I_{L} is neither increasing nor decreasing. Low-power analog circuitry such as an asynchronous counter/timer may be used to determine duration of time t_{HIZ}. Because such duration of time t_{HIZ} may decrease as load current I_{LOAD} increases, once duration of time t_{HIZ} decreases below a predetermined threshold duration, mode controller 112 may infer that load current I_{LOAD} is sufficient to begin transitioning to high-power operation and enabling components of digital controller 110. In some embodiments, the predetermined threshold duration may be a function of the mode of operation of power converter 102 (e.g., buck mode, boost mode, or buck-boost mode).

In addition or alternatively, mode controller 112 may infer the sufficient increase in load current I_{LOAD} by measuring the PFM frequency. Because PFM frequency may increase as load current I_{LOAD} increases, once the PFM frequency increases above a predetermined threshold frequency, mode controller 112 may infer that load current I_{LOAD} is sufficient to begin transitioning to high-power operation and enabling components of digital controller 110.

In addition or alternatively, mode controller 112 may infer the sufficient increase in load current I_{LOAD} by measuring a peak voltage for output voltage V_{OUT}. A PFM pulse may cause a certain amount of ripple within output voltage V_{OUT}. Because such peak voltage may decrease as load current I_{LOAD} increases, once the peak voltage of output voltage V_{OUT} decreases below a predetermined threshold voltage, mode controller 112 may infer that load current I_{LOAD} is sufficient to begin transitioning to high-power operation and enabling components of digital controller 110.

If mode controller 112 infers that an increase in load current I_{LOAD} may incur sufficient to begin enabling components of digital controller 110, method 200 may proceed to step 204, indicated in FIG. 3 at time t₁. Otherwise, method 200 may remain at step 202 until such an increase is inferred.

At step 204, while continuing to operate power converter 102 in the low-power mode, mode controller 112 may assert enable signal DIG_EN to begin enabling components of digital controller 110. However, until such time that components of digital controller 110 are fully enabled, power converter 102 will still need to regulate output voltage V_{OUT} in the low-power mode. Such regulation of output voltage V_{OUT} in the low-power mode may be accomplished in any suitable manner. For example, in some embodiments, mode controller 112 may simply cause PFM operation after time t₁ at the same pre-programmed peak current I_{PK} for power inductor current I_{L} as prior to time t₁. As another example, in other embodiments, mode controller 112 may cause PFM operation after time t₁ at an increased peak current I_{PK} for power inductor current I_{L} higher than peak current I_{PK} as prior to time t₁. Such higher peak current value may be able to support a higher load and extend the amount of time that power converter 102 is maintained in regulation while components of digital controller 110 are turned on.

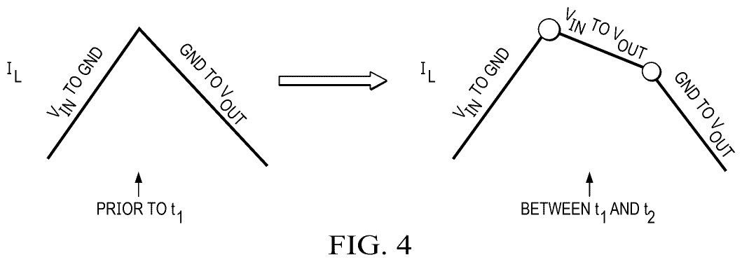

In these and other embodiments, mode controller 112 may cause power converter 102 to, after time t₁, operate in a transitional three-phase mode, rather than a two-phase mode. To illustrate, as shown on the left-hand side of FIG. 4, prior to time t₁, mode controller 112 may cause power converter 102 to operate in a two-phase mode, including a magnetization phase in which power inductor current I_{L} flows from input voltage V_{IN} to ground, and a single demagnetization phase in which power inductor current I_{L} flows from ground to output voltage V_{OUT}. However, as shown on the right-hand side of FIG. 4, between times t₁ and t₂ (significance of time t₂ is described in greater detail below), mode controller 112 may cause power converter 102 to operate in the transitional three-phase mode, including a magnetization phase in which power inductor current I_{L} flows from input voltage V_{IN} to ground, an intermediate phase (e.g., either magnetization phase or a demagnetization phase depending on input voltage V_{IN} and output voltage V_{OUT}) in which power inductor current I_{L} flows from input voltage V_{IN} to output voltage V_{OUT}, and a second demagnetization phase in which power inductor current I_{L} flows from ground to output voltage V_{OUT}. Such operation in the transitional three-phase mode may enable power converter 102 to push more energy during each PFM switching cycle, and may support a higher load and extend the amount of time that power converter 102 is maintained in regulation while components of digital controller 110 are turned on.

At step 206, mode controller 112 may determine if conditions of power converter 102 support operation in the high-power mode of power converter 102. Such determination may be made based on one or more factors that indicate that components of digital controller 110 are powered on and ready to regulate output voltage V_{OUT}. For example, in some embodiments, such condition may be as simple as digital controller 110 communicating a signal to mode controller 112 that digital controller 110 is sufficiently powered on to operate in the high-power mode. As another example, in some embodiments, such condition may include digital controller 110 communicating a signal to mode controller 112 that digital controller 110 is sufficiently powered on to operate in the high-power mode, combined with one or more of the following conditions:
(a) output voltage V_{OUT} decreasing below a predetermined threshold voltage (which may or may not be lower than the predetermined threshold voltage described above with respect to step 202);
(b) duration of time t_{HIZ} decreasing below a predetermined threshold duration (which may or may not be lower than the predetermined threshold duration described above with respect to step 202);
(c) PFM frequency increasing above a predetermined threshold frequency (which may or may not be lower than the predetermined threshold frequency described above with respect to step 202); and/or (
d) detection of a critical conduction current level condition in power converter 102.

If mode controller 112 determines conditions of power converter 102 support operation in the high-power mode, method 200 may proceed to step 208, indicated in FIG. 3 at time t₂. Otherwise, method 200 may remain at step 206 until conditions of power converter 102 support operation in the high-power mode.

At step 208, mode controller 112 may cause power converter 102 to operate in the high-power mode by fully enabling digital controller 110, and disabling all or a portion of the components of analog controller 108 (e.g., by deasserting enable signal ANA_EN). In some embodiments, mode controller 112 may ensure a smooth transition to the high-power mode with minimal voltage undershoot by further initializing state variables for any control loops of digital controller 110. After completion of step 208, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of system 100 and/or any other system operable to implement method 200. In certain embodiments, method 200 may be implemented partially or fully in software and/or firmware embodied in computer-readable media, which may be executed on processor to perform method 200.

To avoid chatter between operation in the low-power mode and the high-power mode, mode controller 112 may apply hysteresis. For example, mode controller 112 may trigger a transition from the high-power mode to the low-power mode when an average of power inductor current I_{L} falls below a predetermined threshold current level, wherein such predetermined threshold current level is set such that the resulting PFM frequency is well below the predetermined threshold frequency for triggering transition to the high-power mode and/or the resulting duration of time t_{HIZ} is well above the predetermined threshold duration for triggering transition to the high-power mode.

The systems and methods described herein may provide for early detection of an increased load on the output of a power converter, and enabling components of a digital controller of the power converter based on the early detection while maintaining regulation in a low-power (e.g., DCM/PFM) mode of operation until the components of the digital controller are sufficiently powered on for operation in a high-power (e.g., CCM/PWM) mode of operation. Further, the systems and methods described herein may provide for full transition into the high-power mode of operation when the components of the digital controller are sufficiently powered on and/or other criteria for transitioning to the high-power mode of operation are satisfied.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in FIG. 1s and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a power converter configured to operate in a plurality of modes including a low-power mode, a transitional mode, and a high-power mode, and further configured to generate a load current to a load coupled to the output of the power converter; and
a controller configured to:
during operation in the low-power mode, infer an increase in the load current;
in response to inferring the increase in the load current, enter the transitional mode to enable circuitry associated with the high-power mode; and
transition from the transitional mode to operation in the high-power mode once the circuitry associated with the high-power mode is fully enabled.

2. The system of claim 1, wherein the controller is further configured to, during the transitional mode, modify a control parameter for controlling the power converter in the low-power mode to extend the ability of the power converter to regulate the load current in the transitional mode until the power converter is transitioned to operation in the high-power mode.

3. The system of claim 2, wherein modification of the control parameter increases a magnetization phase for a power inductor of the power converter.

4. The system of claim 2, wherein modification of the control parameter causes operation of the power converter in three phases for each switching pulse of the power converter.

5. The system of claim 1, further comprising an analog controller configured to control switches of the power converter during the low-power mode.

6. The system of claim 1, further comprising a digital controller configured to control switches of the power converter during the high-power mode.

7. The system of claim 1, wherein inferring an increase in the load current is based on comparing a duration between successive switching pulses of the power converter to a predetermined threshold duration.

8. The system of claim 1, wherein inferring an increase in the load current is based on comparing a frequency of switching pulses of the power converter to a predetermined threshold frequency.

9. The system of claim 1, wherein inferring an increase in the load current is based on comparing a peak of a voltage ripple of an output voltage at the output of the power converter to a predetermined threshold voltage value.

10. A method comprising, in a system having a power converter configured to operate in a plurality of modes including a low-power mode, a transitional mode, and a high-power mode, and further configured to generate a load current to a load coupled to the output of the power converter:
during operation in the low-power mode, inferring an increase in the load current;
in response to inferring the increase in the load current, entering the transitional mode to enable circuitry associated with the high-power mode; and
transitioning from the transitional mode to operation in the high-power mode once the circuitry associated with the high-power mode is fully enabled.

11. The method of claim 10, further comprising, during the transitional mode, modifying a control parameter for controlling the power converter in the low-power mode to extend the ability of the power converter to regulate the load current in the transitional mode until the power converter is transitioned to operation in the high-power mode.

12. The method of claim 11, wherein modification of the control parameter increases a magnetization phase for a power inductor of the power converter.

13. The method of claim 11, wherein modification of the control parameter causes operation of the power converter in three phases for each switching pulse of the power converter.

14. The method of claim 10, wherein the system further comprises an analog controller configured to control switches of the power converter during the low-power mode.

15. The method of claim 10, wherein the system further comprises a digital controller configured to control switches of the power converter during the high-power mode.

16. The method of claim 10, wherein inferring an increase in the load current is based on comparing a duration between successive switching pulses of the power converter to a predetermined threshold duration.

10. The method of claim 10, wherein inferring an increase in the load current is based on comparing a frequency of switching pulses of the power converter to a predetermined threshold frequency.

18. The method of claim 10, wherein inferring an increase in the load current is based on comparing a peak of a voltage ripple of an output voltage at the output of the power converter to a predetermined threshold voltage value.
